(19) United States
(12) Patent Application Publication
(10) Pub. No.: US 2012/0272798 A1
(43) Pub. Date: Nov. 1, 2012

(54) Hedge Trimmer Extension Adaptor

(76) Inventor: Frank Houghton, Milpitas, CA (US)

(21) Appl. No.: 13/097,779

(22) Filed: Apr. 29, 2011

(51) Int. Cl. B26D 1/00; B23P 23/00; B26B 19/00

(52) U.S. Cl. 83/13; 30/272.1; 29/401.1

(57) ABSTRACT

A Hedge Trimmer Extension Adaptor is disclosed. A device for adapting a standard hedge trimmer (electric, battery or gas powered) so that the operator can reach and trim hedges that are normally beyond the operator's reach either vertically, horizontally or both, without resorting to ascending a ladder or other unsafe efforts.

The tool consists of four parts. The hedge trimmer is a commercially available electric hedge trimmer. The switch assembly, the support pole assembly, and the upper tray adaptor are the other three parts. The support pole assembly is screwed into the “Hedge Trimmer Extension Adaptor” system and is the handle the operator holds onto. The switch assembly snaps onto the support pole assembly and is used to control the hedge trimmer. This product is very novel because of the simplicity of the design and the snap together construction. The design incorporates a significant amount of adjustability and features and it is only composed of two major parts.

### BACKGROUND OF THE INVENTION

1. Field of the Invention

The present invention relates to a device for adapting a standard hedge trimmer (electric, battery or gas powered) so that the operator can reach and trim hedges that are normally out of reach of the operator, without resorting to ascending a ladder or other unsafe efforts.

2. Description of the Prior Art

Powered hedge trimmers are handy tools for grooming shrubs and hedges in a fraction of the time it would take with manual clippers. Most residential hedge trimmers have a blade measuring 16 to 25 inches long with a cutting surface on both sides for shaping shrubs. Hedge trimmers may be powered by electricity, a rechargeable battery or gas.

Corded electric hedge trimmers are lightweight, quiet and easy to start, making them the most popular choice for residential use. However, they require an electrical outlet and lengthy extension cord, which can easily tangle on obstacles while trimming. Cordless hedge trimmers, on the other hand, are equally quiet and easy to start, and the rechargeable battery offers more freedom of movement. The trade-off is less cutting power and a limited run time (unless you have a backup battery). Gas-powered hedge trimmers are favored by homeowners and yard maintenance professionals who need mobility and maximum cutting capability. Many residential users find gas-powered hedge trimmers to be loud, heavy and an effort to start, to say nothing of the fumes the engine produces. They also require periodically replacing the air and fuel filters.

Most people who need to trim shrubs and other foliage in their yard prefer corded electric hedge trimmers, which are cheaper than gas trimmers or cordless electric models, quiet to operate, lightweight and don't run out of fuel. Corded hedge trimmers are available in a variety of blade lengths; the longer the blade, the faster you'll be able to finish a big job. Maximum branch diameter cutting capacity is dependent on the motor size (more amps equals more power) and the gap between teeth on the blade, typically ½ inch to ¾ inch. The main drawbacks to corded hedge trimmers are that you're tethered to an extension cord, and keeping that cord from becoming tangled in branches while trimming.

When pruning tall hedges, the operator must usually resort to ascending a ladder or other unsafe efforts because he can't reach and trim branches that at or near the top of his bush. The ideal “Hedge Trimmer Extension Adaptor” would extend the operator's reach, so that he could reach out and up to trim all branches. It would also have a method for quickly and easily changing the angle and locking in the new angle of the cutting blade to the support pole, held by the operator, so that a reasonable number of sides of a hedge could be attacked from one position. The adaptor would also be able to facilitate the use of any of hundreds of different hedge trimmers that are currently available on the market, with no adjustment. This adaptor should also give the operator a method of controlling the operation of the hedge trimmer at all times, so that the operator is not placed in danger or branches cut by accident. Finally, this adaptor should be easy to manufacture and snap together so that this small proportion of the hedge trimmer system does not abnormally burden the overall system.

Notwithstanding these inconveniences, few improvements have been introduced to solve these problems.

Banta, E T. al (U.S. Pat. No. 5,070576) describes a “Hedge Trimmer Extension Handle” for use with the Black & Decker electric hedge trimmer, that can quickly attach to this hedge trimmer to reach vegetation which is beyond the user's reach vertically, horizontally, or both. This proposed embodiment has the limitations that it must be used with only one particular make and size hedge trimmer. It also has no means to adjust the angle of the blade so that as many sides of the bush can be reached for one position as possible. It is also assumed that the control trigger on the hedge trimmer will be locked in the “on” position while the trimmer is maneuvered around the hedge for trimming. This condition puts the operator in significant danger and also could facilitate trimming braches that the operator did not wish to trim.

Drake, E T. al (U.S. Pat. No. 4,638,562) describes an “Extension Handles for Hedge Trimmer”. This device is severely limited in design and use because it encloses the hedge trimmer being supported by a clamping box. This will limit the use of this device to only hedge trimmers that can fit tightly in this box. The described device does have a provision for changing the angle of the blade with respect to the support pole, but the mechanism described is very cumbersome and only allows the operator the choice between two positions, which is not adequate. It is also assumed that the control trigger on the hedge trimmer will be locked in the “on” position while the trimmer is maneuvered around the hedge for trimming. This condition puts the operator in significant danger and also could facilitate trimming branches that the operator did not wish to trim. The use of this device would significantly burden the value of any trimmer system.

Ott, E T. All (U.S. Pat. No. 3,218,789) describes a rotary lawn and hedge trimmer device, which configures a household electric drill as a lawn edger or hedge trimmer. This device holds the drill and includes a handle so that the operator can stand erect and trim the lawn. However, when the device is used as a hedge trimmer, the handle is removed in order to make the device more convenient.

### OBJECTS AND ADVANTAGES

Accordingly, several objects and advantages of my invention are that it would extend the operator's reach, so that he could reach out and up to trim all branches of the bush he is working on. It also has a method for quickly and easily changing the angle of the cutting blade to the support pole, held by the operator, so that a reasonable number of sides of a hedge could be attacked form one position. The reason this feature is paramount is that the operator may not be able to re-position himself to reach some branches of the bush because of a physical constraint, such as a fence. The adaptor is also able to accommodate any of hundreds of different hedge trimmers that are currently available on the market, with no adjustment. This adaptor also gives the operator a method of controlling the operation of the hedge trimmer at all times, so that the operator is not placed in danger or branches cut by accident. Finally, this adaptor is easy to manufacture and snap together so that this small proportion of the hedge trimmer system does not abnormally burden the overall system.

### LIST OF REFERENCE NUMBERS

100 Hedge Trimmer

101 Extendable Pole

102 Upper Tray Adaptor

103 Lower Clevis Adaptor

104 Back Strap

105 Front Strap

106 Switch Housing

107 Trigger Switch

108 Wire Switch

109 Switch

110 Screw

111 Switch Assembly

### DESCRIPTION OF INVENTION

The present invention provides a new and simple to use hedge trimmer system which can be used quickly without the need of any tool to extending the reach of the operator of any manufactures' hedge trimmer. This tool is very versatile and yet very simple in design. It allows the operator to change the angular position of the hedge trimmer with respect to the supporting pole to facilitate the reaching of most sides of the hedge from a fixed position, without disassembling the unit. By pushing one button, the operator can make this angular adjustment.

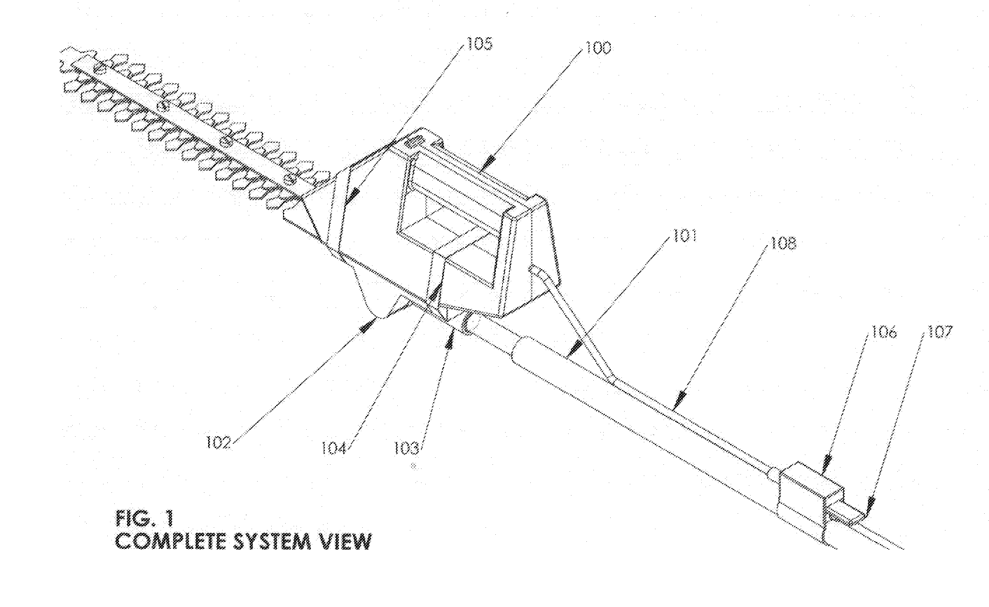

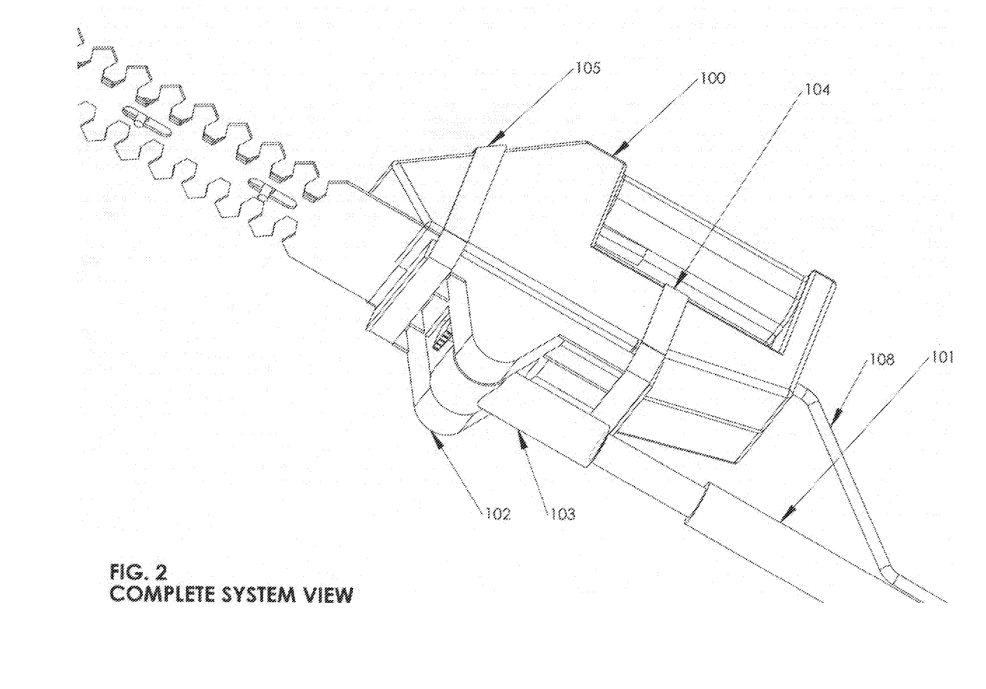

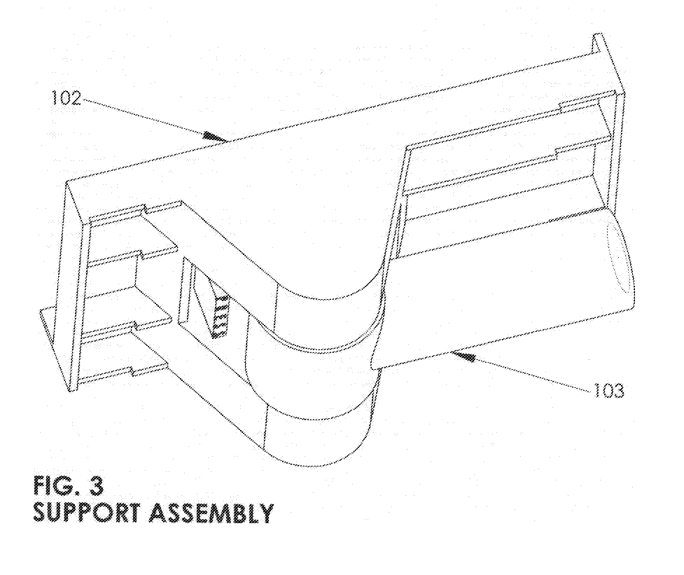

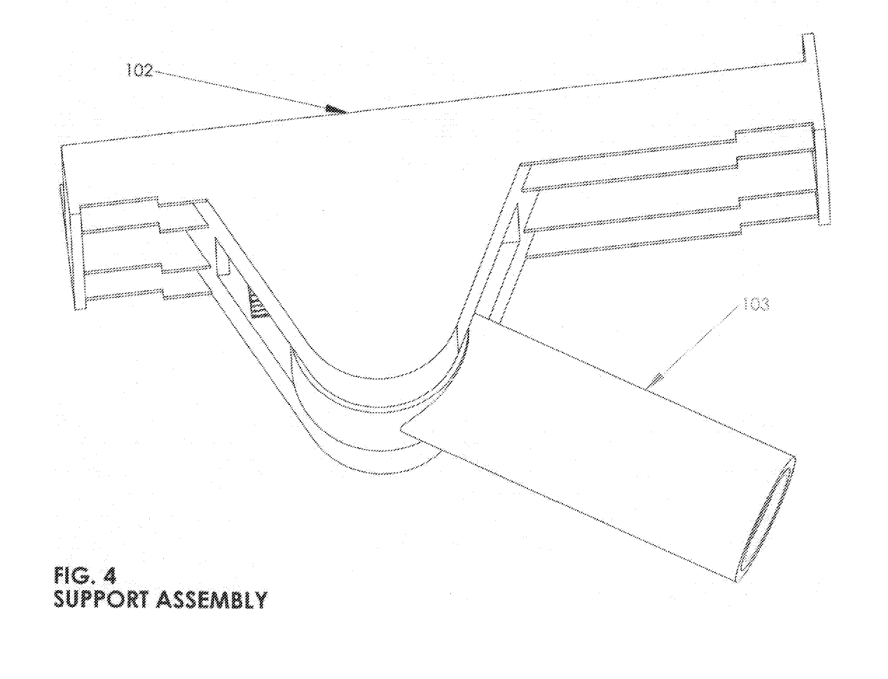

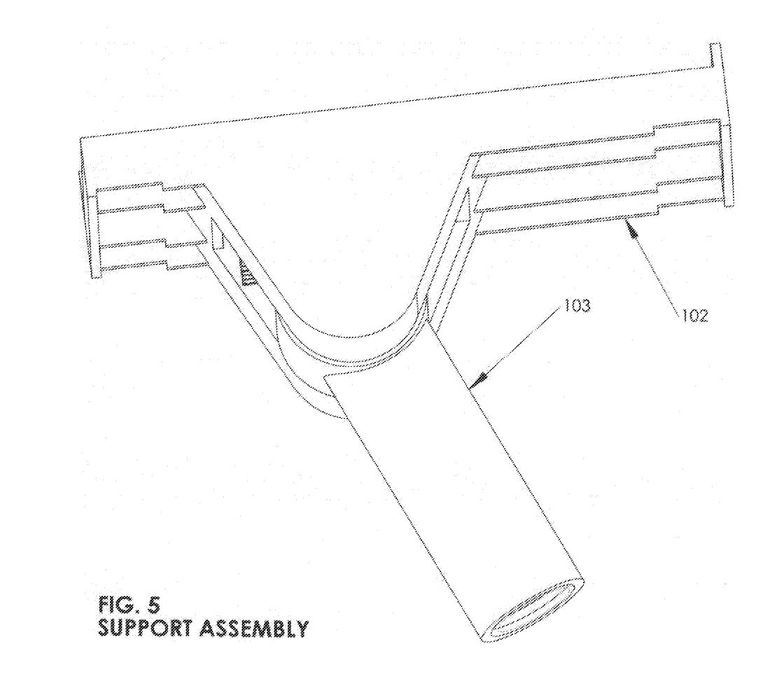

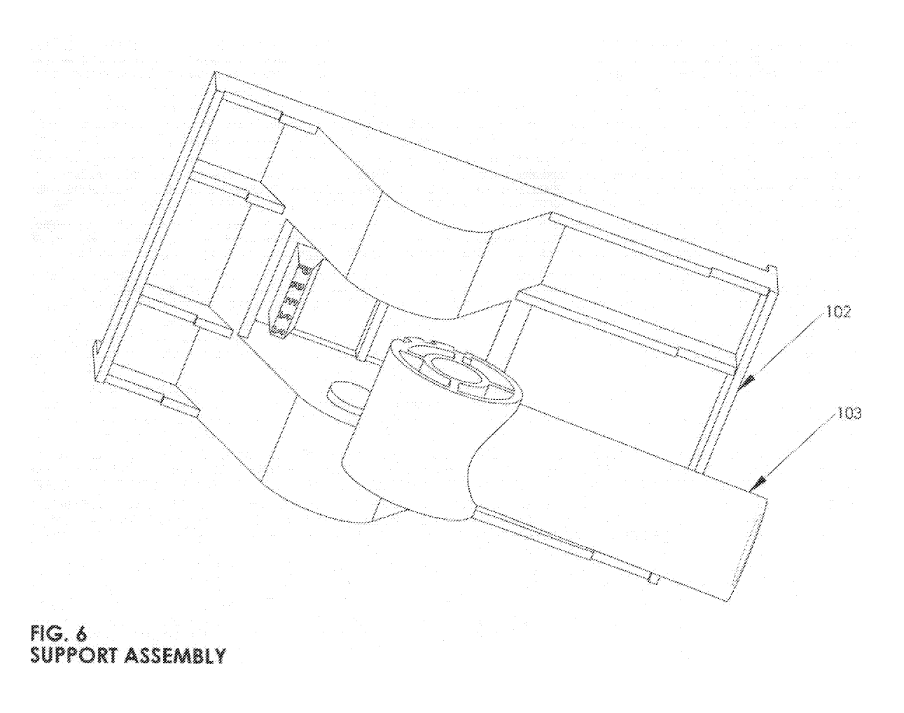

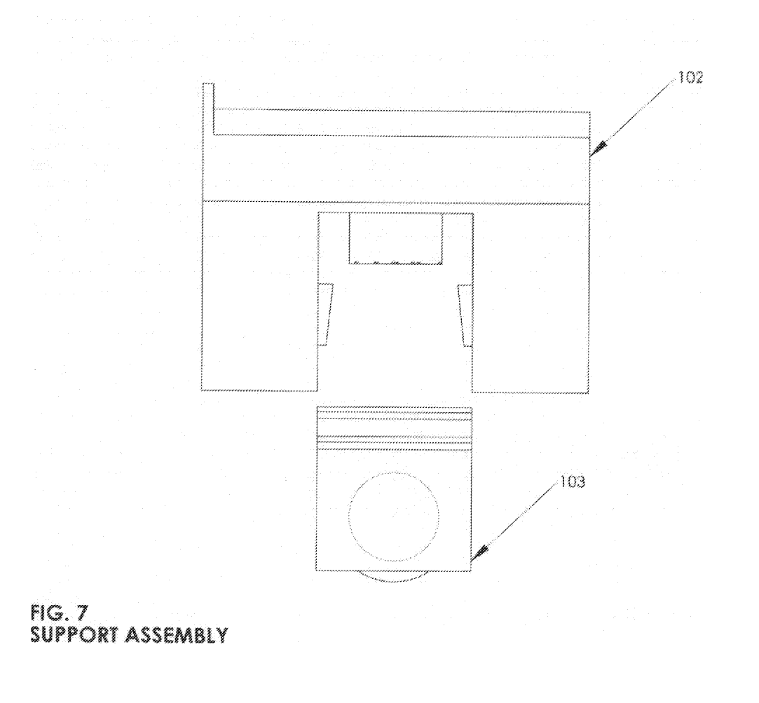

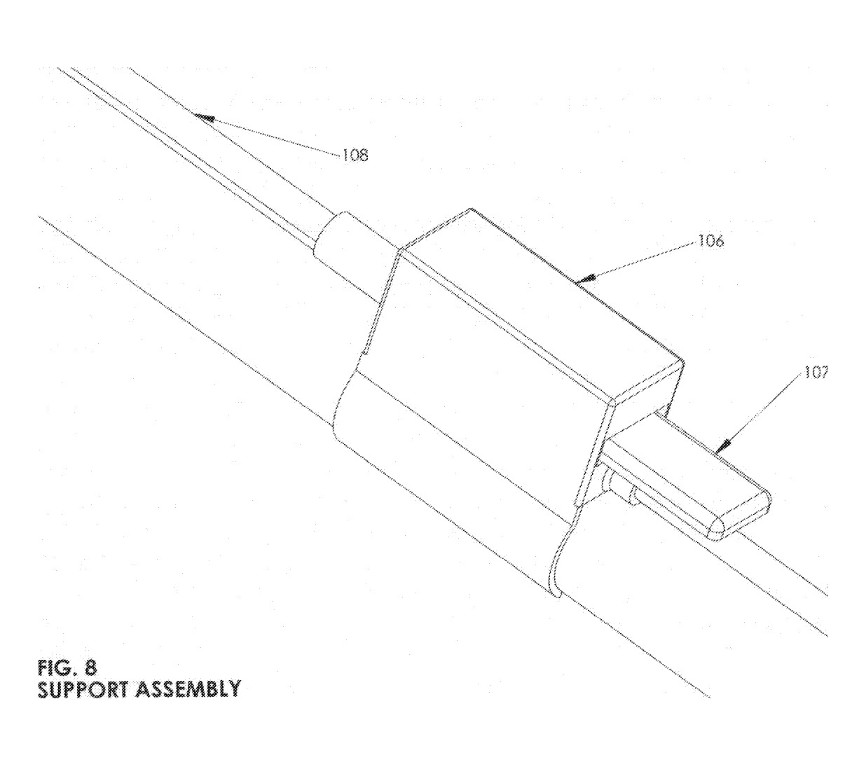

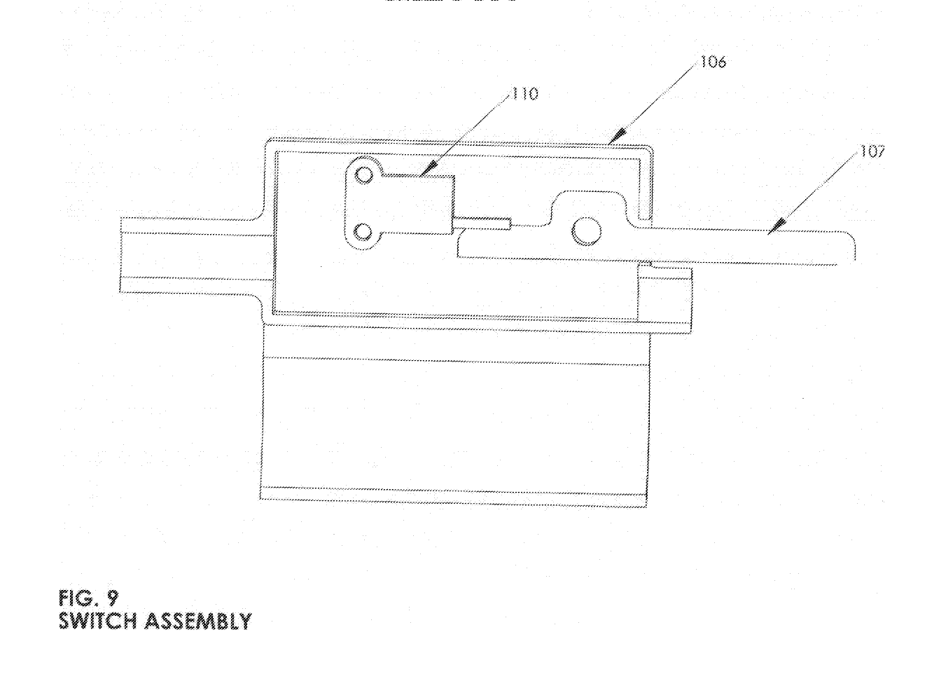

FIG. 1 is a complete system view of the invention, with a hedge trimmer in place and support pole screwed into 103 Lower Clevis Adaptor with the 111 Switch Assembly mounted to the support pole. FIG. 2 is a close-up view of the 100 Hedge Trimmer mounted on the invention. FIG. 3 is a view of my invention, with the 103 Lower Clevis Adaptor support horizontal. FIG. 4 is a view of my invention, with the 103 Lower Clevis Adaptor at 45 degrees. FIG. 5 is a view of my invention, with the 103 Lower Clevis Adaptor near vertical. FIG. 6 is an exploded view that shows the angle adjusting apparatus. FIG. 7 is an exploded view that shows the snap assembly features between the 103 Lower Clevis Adaptor and the 102 Upper Tray Adaptor structures. FIG. 8 is a view of the 111 Control Switch Assembly mounted to the Support Pole. FIG. 9 is a cross section view of the 111 Control Switch Assembly showing the internal mechanism.

FIG. 1 shows an overall view of the “Hedge Trimmer Extension Adaptor” system. The “Hedge Trimmer Extension Adaptor” system is composed of four major assemblies. The hedge trimmer is a commercially available electric hedge trimmer. An electric hedge trimmer is shown, but many of the features directly apply to either a battery powered or gas hedge trimmer. The 111 Switch Assembly would not be used with a gas or battery powered hedge trimmer. The 101 Extendable Pole assembly is screwed into the “Hedge Trimmer Extension Adaptor” system. The 111 Switch Assembly snaps onto the 101 Extendable Pole and one end of the 108 Wire Switch plugs into the hedge trimmer, and the other end plugs into a cord supplying the electrical power for the hedge trimmer assembly. The operator's thumb activates the 107 Trigger Switch on the 111 Switch Assembly by depresses the 107 Trigger Switch which activates the cutting bar on the hedge trimmer. The operator has complete control of the 100 Hedge Trimmer Assembly at all times. The 100 Hedge Trimmer is secured to the “Hedge Trimmer Extension Adaptor” by 104 & 105 Back & Front Straps. One strap 104 is at the front of the hedge trimmer and one 105 at the back. These 104 & 105 Back & Front Straps (Velcro) are mounted to the 102 Upper Tray Adaptor and firmly secure the 100 Hedge Trimmer against the 102 Upper Tray Adaptor.

FIG. 2 shows a close-up view of the 100 Hedge Trimmer mounted on the 102 Upper Tray Adaptor. The position and use of the 104 & 105 Back & Front Straps is shown very clearly. This view also shows the 103 Lower Clevis Adaptor in a horizontal position, which would facilitate an extended reach in the horizontal direction for the operator.

FIG. 3 shows a close up view of the “Hedge Trimmer Extension Adaptor”. This part consists of two parts 102 Upper Tray Adaptor and 103 Lower Clevis Adaptor. The relative position of the 101 Extendable Pole that screws into the 103 Lower Clevis Adaptor is controlled by pressing the button marked “press” on the 102 Upper Tray Adaptor. Once this button is pressed the 103 Lower Clevis Adaptor is free to rotate about the stub shafts in 102 Upper Tray Adaptor that can be seen in FIG. 7. The operator rotates the 103 Lower Clevis Adaptor to the detent position in the 103 Lower Clevis Adaptor hub that is closest to the angle desired for the next bush cut. The 103 Lower Clevis Adaptor has many available detents for the operator to choose from, so that the operator can obtain near optimum angle for the cutting blade for each cut.

FIG. 4 shows a different angle for the 103 Lower Clevis Adaptor versus the 102 Upper Tray Adaptor.

FIG. 5 shows again a different angle for the 103 Lower Clevis Adaptor versus the 102 Upper Tray Adaptor.

FIG. 6 shows the relative position of the detent slots in the 103 Lower Clevis Adaptor and the detent paw that is lower into these slots as the “press” button is depressed. This system provides an easily adjustable angle for the 100 Hedge Trimmer and a positive lock that makes the whole system sturdy and stable.

FIG. 7 shows how the 103 Lower Clevis Adaptor is assembled into the 102 Upper Tray Adaptor. The 103 Lower Clevis Adaptor is pressed into the opening between the arms of the 102 Upper Tray Adaptor. Because of the angle on the stub shafts in the 102 Upper Tray Adaptor the 103 Lower Clevis Adaptor bows out the legs of the 102 Upper Tray Adaptor until the stub shafts fall into the pivot holes in the 103 Lower Tray Adaptor. Once the stub shafts are in the holes the two parts are securely bound together. While this is happening the detent paw is also inserted into the detent slot in 103 Lower Tray Adaptor.

FIG. 8 shows the overall construction and position of the control switch. The control switch assembly snaps onto the 101 Extendable Pole. Out the top end of the 111 Switch Assembly extends an electrical cord that is plugged into the 100 Hedge Trimmer. Out the lower end of the 111 Switch Assembly is an electrical cord that is plugged into the supply line cord used to run the 100 Hedge Trimmer. The purpose of the 111 Switch Assembly is to interrupt power to the 100 Hedge Trimmer until the operator presses the 107 Trigger Switch with his thumb. The operator will be controlling the 101 Extendable Pole position by holding it with both of his hands. The control of the position of the 101 Extendable Pole position also guarantees the operator has firm control over the 102 Upper Tray Adaptor and therefore also the 100 Hedge Trimmer.

FIG. 9 shows the internal detail construction of the switch assembly. The 107 Trigger Switch presses on the 110 Switch that allows electrical current to flow to the 100 Hedge Trimmer when the 107 Trigger Switch is depressed.

### OPERATION OF INVENTION

FIG. 1 shows the tool according to the preferred embodiment of the invention. The tool comprises a 102 Upper Tray Adaptor and a 103 Lower Clevis Adaptor that are preferably made of plastic. The operator will mount his 100 Hedge Trimmer into the 102 Upper Tray Adaptor and secure the 100 Hedge Trimmer by adjusting the 104 & 105 Back & Front Straps, provided. The operator will then plug into the 100 Hedge Trimmer the 108 Wire Switch female end and plug in the 108 Wire Switch male end into a suitable electrical outlet. The operator will then lock the 100 Hedge Trimmer trigger into the “on” position by using the controls on the 100 Hedge Trimmer. He will then screw the 101 Extendable Pole into the 103 Lower Clevis Adaptor and snap the 111 Switch Assembly onto the 101 Extendable Pole. The complete assembly is now ready to trim bushes. The operator will then position the 100 Hedge Trimmer against the area of the bush he wishes to trim and depress the 107 Trigger switch. When the trigger is depressed, electrical energy is sent from the electrical source to the 100 Hedge Trimmer and the trimmer motor is activated and the blades activate and trim the bush. When the operator releases the trigger, the motor spins to a stop and the tool will stay in the “off” state until the trigger is depressed again.

The operator may need to change the angle of the blades with respect to the 101 Extendable Pole to reach different portions of the bush. This effort is accomplished by depressing the button on the 102 Upper Tray Adaptor marked “press” and then simply moving the 100 Hedge Trimmer to the desired angle and releasing the button. The operator can then trim the portion of the hedge that he could not reach with the pervious angle setting.

### CONCLUSIONS AND SCOPE OF INVENTION

Thus the reader will see that the Hedge Trimmer Extension Adaptor invention provides a highly reliable, lightweight, yet economical device that allows the operator to extend his reach to trim many different faces of a bush from one position.

While my above description contains many specificities, these should not be construed as limitations on the scope of the invention, rather as an exemplification of one preferred embodiment thereof. Many other variations are possible. For example, the 102 Upper Tray Adaptor & the 103 Lower Clevis Adaptor could be constructed for metals to add rigidity to the tool. The tool could be used without the 111 Switch Assembly, to save cost, but safety and utility will be sacrificed. The size and shape of the tool could be modified slightly to accommodate larger, heavier, gas hedge trimmers, but the design concepts will be the same.

Accordingly, the scope of the invention should be determined not by the embodiment illustrated, but by the appended claims and their legal equivalents.

Citations

| Pat. No. | Title | Issue date |
|---|---|---|
| 1,779,031 | | October 1930 |
| 1,897,543 | CA Albrecht hedge cutter | February 1933 |
| 2,153,771 | Grass cutter and hedge trimmer | April 1939 |
| 2,718,231 | Support for hair cutting clippers | September 1955 |
| 2,762,186 | Janata hedge trimming machine | September 1956 |
| 3,218,789 | Lawn edger and hedge trimmer | November 1965 |
| 4,197,764 | Detachable handle assembly | April 1980 |
| 4,207,675 | Adjustable utility extension handle for | June 1980 |
| | electrically powered hand tool | |
| 4,317,282 | Wood sanding, grass and wood cutting | March 1982 |
| | electric drill attachment device | |
| 4,515,423 | Extension device for electrically powered | May 1985 |
| | tools | |
| 4,638,562 | Extension handles for hedge trimmers | January 1987 |
| 4,976,031 | Telescopic hedge trimmer apparatus | December 1990 |
| 5,070,576 | Hedge trimmer extension handle apparatus | Dec. 10, 1991 |

We claim:

1. A method for quickly and easily changing the angle and locking in the new angle of the cutting blade to the support pole.
The ability to facilitate the use of any of hundreds of different hedge trimmers that are currently available on the market, with no adjustment.
A method of controlling the operation of the hedge trimmer at all times, so that the operator is not placed in danger or branches cut by accident.
An adaptor that is easy to manufacture and snap together so that this small proportion of the hedge trimmer system does not abnormally burden the overall system.

2. A device as in claim 1 where the device is constructed out of metal, for increased rigidity.

3. A device as in claim 1 where the size and shape of the tool is modified slightly to accommodate larger, heavier, gas hedge trimmers, but the design concepts will be the same.

4. A device as in claim 1 where a friction lock instead of the present detent lock locks the angular position of the hedge trimmer in place.

5. A device as in claim 1 but without the embodiment of the control switch assembly, to save cost.

6. A device as in claim 1 where the Velcro straps are replaced with similar but different strapping methods.

7. A device as in claim 1 where the device is made of only one part with no angular adjustment to save cost.
